(19) United States
(12) Patent Application Publication
(10) Pub. No.: US 2012/0282589 A1
(43) Pub. Date: Nov. 8, 2012

(54) Air bag simulator / educational device and method

(76) Inventor: Adelore F. Petrie, Arlington Heights, IL (US)

(21) Appl. No.: 13/068,218

(22) Filed: May 4, 2011

(51) Int. Cl. G09B 25/00

(52) U.S. Cl. 434/373

(57) ABSTRACT

An air bag simulator device essentially functions to educate drivers on proper seat-body position relative to a vehicular air bag deployment zone. The air bag simulator device comprises an air bag-simulating envelope, sized and shaped to simulate a deployed driver side, vehicular air bag. The air bag-simulating envelope defines a certain volumetric space filled with certain matter. The air bag-simulating envelope is positionable adjacent a vehicular steering wheel for visually demonstrating to a user the volumetric space otherwise occupied by a deployed driver side vehicular air bag. The driver, having the air bag simulating device in position, may thus properly position his or her seat and/or body to accommodate the air bag simulating device. Once having learned to anticipate the volumetric space defined by the air bag simulating device, the driver may repeat the process so as to avoid being struck by a vehicular air bag during a deployment.

### BACKGROUND OF THE INVENTION

1. Field of the Invention

The present invention generally relates to air bag simulator device. More particularly, the present invention relates to an air bag simulator device for educating vehicle occupants as to proper bodily position relative to vehicular air bags in the event of air bag deployment.

2. Brief Description of the Prior Art

In typical, state of the art automobiles, air bags protect vehicle occupants from colliding with vehicular objects such as the steering wheel, dashboard, or windshield in a severe crash situation. In order to properly engage the vehicle occupant(s), an air bag must deploy very quickly to protect the vehicular occupant(s) in a high speed crash. In this regard, it is noted that an air bag typically deploys at speeds of 200 to 300 miles per hour in order to be properly positioned before the vehicle occupant engages the air bag. In other words, air bags are designed to deploy quickly to be in proper position before the occupant collides with the air bag, and are not designed to strike the occupant during deployment.

Nevertheless, drivers of automobiles often incorrectly position themselves relative to an air bag deployment site because a typical driver does not comprehend or understand (1) how fast the air bag expands or deploys in a crash situation, and (2) the volumetric space the air bag occupies during and after its deployment. Thus, it is contemplated that if a vehicle occupant could visualize an example of a typical air bag pre-deployed and occupying the volumetric space heretofore noted while positioned within the vehicle, the vehicle occupant could well adjust his or her seat and/or bodily position so as to avoid the volumetric space otherwise occupied by the air bag.

As a means to teach vehicle occupants as to correct body position, driver safety instructors often orally described an air bag deployment scenario to a driver as accompanied by the use of a ruler to measure anticipated distances from the air bag deployment site to the occupant so as to visually illustrate and/or indicate where the driver should position his or her body. This technique requires a significant level of imagination for both the instructor and the driver to arrive at the proper bodily position for both the seat and driver.

Standard air bag systems do not address proper vehicle occupant position and thus are not suitable for simulating air bag deployments and/or educating the vehicle occupants as to proper body position. A standard air bag, rather, is sized and shaped to deploy from air bag storage compartments within the vehicle, and often comprise various means for enabling and/or allowing rapid deflation during and following occupant engagement for the purpose of slowing the deceleration of the bag-engaging occupant.

Some of the more pertinent art relating to air bag systems and the like for properly positioning a vehicle occupant relative to the air bag deployment sites is briefly described hereinafter. U.S. Pat. No. 5,492,359 ('359 Patent), which issued to Oliver, for example, discloses a Personal Manually Acutable Safety Restraint Gas Bag Shield. The '359 Patent describes a portable, personal, manually-activated safety restraining gas bag shield comprising a bag formed solely of gas-impermeable non-expandable fabric which is adapted to be selectively provided either in a deflated condition or in an inflated condition.

A pocket in the bag having access means to the interior of the bag and controlled by a manually-actuatable, one-way valve to provide for gas to the interior of the bag. A cylinder of compressed gas is disposed within the pocket the cylinder including a closed nozzle connected to the manually-controlled, one-way valve for inflating the bag. Manually actuatable structure is provided to operate the manually-actuatable valve, thereby to control the flow of gas released from the cylinder into the interior of the bag.

U.S. Pat. No. 5,573,269 ('269 Patent), which issued to Gentry et al, discloses an Apparatus and Method for Sensing and Restraining an Occupant of a Vehicle Seat. The '269 Patent describes an apparatus comprising a weight sensor and a seat incline sensor. The weight sensor senses a sensed weight of the occupant of the seat. The sensed weight differs from the actual weight of the occupant. The incline sensor senses a characteristic which affects the difference between the sensed weight and the actual weight of the occupant. The apparatus further includes a controller and an inflatable vehicle occupant restraint. The controller determines a computed weight of the occupant as a function of both the sensed weight and the characteristic. Inflation fluid is directed into the restraint to inflate the restraint and is controlled in response to the computed weight determined by the controller.

U.S. Pat. No. 5,670,853 ('853 Patent), which issued to Bauer, discloses a Method and Apparatus for Controlling Vehicle Occupant Position. The '853 Patent describes certain methodology for controlling the position of an occupant in a vehicle passenger compartment by sensing physical characteristics of the occupant such as weight, height, girth, and leg length. A controller controls seat motors to move the occupant to a position based on the sensed physical characteristics of the occupant. The occupant can override the system using override controls. The controller also adjusts the performance of an occupant restraint in response to a selected occupant position.

U.S. Pat. No. 5,868,423 ('423 Patent), which issued to Takimoto et al., discloses an Air Bag System. The '423 Patent describes an air bag system in which there is employed a control device which can control the internal pressure of an air bag after expanded in such a manner that a buffer distance, for which the air bag after expanded can be compressed when it is contacted with an occupant, can be kept constant regardless of an increase or a decrease in the weight or the like of the occupant. In operation, the control device firstly takes out the acceleration data of the occupant corresponding to the degree of a collision in accordance with a signal from an acceleration sensor.

Next, in accordance with the thus taken-out acceleration, a distance from the air bag before expanded to the head and bosom portion of the occupant obtained based on a signal from a distance sensor, and the weight of the occupant head and bosom portion obtained based on a signal from a weight sensor, the control device calculates a proper value of the internal pressure of the air bag according to a velocity/distance/power balancing condition equation, and controls a gas generation device in such a manner it can produce a generated gas pressure corresponding to the thus calculated proper value.

U.S. Pat. No. 5,924,726 ('726 Patent), which issued to Pan, discloses a Fasten-on Supplemental Restraint System. The '726 Patent describes a fasten-on supplemental restraint system comprising a detecting circuitry and an air bag assembly is provided. The supplemental restraint system is independently located in the vehicle and works with the existing safety belt system. The supplemental restraint system can be readily attached by means of buckle so that the air bag assembly can be readily placed in front of the driver/passenger. Once the air bag body of the air bag assembly is inflated, the direction of expansion is directed forward and outward from the driver/passenger. With this arrangement, the potential risk of being injured by the deployment of the air bag body is therefore eliminated.

U.S. Pat. No. 5,997,033 ('033 Patent), which was issued to Gray et al., discloses an Adaptive Airbag Inflation Method and Apparatus. The '033 Patent describes an airbag system comprising an occupant position sensor and a vehicle speed sensor. Desired initial restraining force is calculated from speed at impact and the occupant's mass, and an appropriate degree of inflation is effected. The occupant speed is continuously calculated from the position sensor signal and the vehicle speed. A target speed profile is established based on an estimated restraint period and the vehicle speed, and an airbag vent is varied to control the occupant speed to the target speed. The target speed profile is adjusted as a function of passenger compartment acceleration to account for vehicle speed variations and for vehicle crush.

U.S. Pat. No. 6,487,483 ('483 Patent), which issued to Gillis, discloses a System and Method of Occupant Sensing. The '483 Patent describes a system and method for determining vehicle occupant characteristics. A plurality of sensors senses a parameter and output a parameter indicative signal. The sensors are arranged in a plurality of groups with each sensor of a group sensing a similar parameter value. A controller utilizes only a portion of the sensors within each group to make a determination regarding the occupant characteristic.

U.S. Pat. No. 6,624,641 ('641 Patent), which issued to Krampitz et al., discloses an Air Bag Simulator and Method of Simulating an Air Bag. The '641 Patent describes an air bag simulator comprising a circuit that provides selectable resistance values between 0.5 ohms and 6.0 ohms. The air bag simulator can be used to simulate the resistance of a number of air bag models and can simultaneously simulate both the driver side and passenger side airbag.

A first output of the air bag simulator has at least a first and a second electrical contact, wherein the first electrical contact is connected to a switch having a plurality of output terminals. Each of the output terminals are connected to a first end of different resistance loads, and the second ends of the resistance loads are connected to the second electrical contacts. The first electrical contact is configured to provide a connection to a power transmitter adapted to communicate with an air bag system.

From a consideration of the foregoing, it will be seen that the prior art appears to be silent on a convenient and inexpensive air bag simulator or educational device outfittable within a vehicle and when so outfitted sized and shaped to aid vehicle occupants more readily visualize the volumetric space otherwise occupied by a deployed air bag so that the vehicle occupant may easily adjust his or her bodily position for maximum safety in the unfortunate event of an air bag deployment. Accordingly, the prior art perceives a need for such a device, as summarized in more detail hereinafter.

### SUMMARY OF THE INVENTION

A primary object of the present invention is to provide a car dealer or a driver safety instructor with a device that represents or simulates a fully deployed driver side air bag that can be temporarily outfitted upon a standard steering wheel to demonstrate to a driver the volumetric space occupied by a fully deployed airbag. The driver, having the air bag simulating device in position, may thus properly position his or her seat and/or body to accommodate the air bag simulating device.

Once having learned to anticipate the volumetric space defined by the air bag simulating device, the driver may repeat the process so as to avoid being struck by a vehicular air bag during a deployment. In other words, the present invention temporarily takes the place of a fully deployed air bag to demonstrate to a driver the proper positioning of the driver's seat and body to avoid injury during a crash.

### BRIEF DESCRIPTION OF THE DRAWINGS

Other features of my invention will become more evident from a consideration of the following brief descriptions of patent drawings:

FIG. 1 is an anterior or frontal plan depiction of the air bag simulator device according to the present invention with parts broken away to depict internal volumetric space in a first dimension.

FIG. 1(a) is an enlarged fragmentary sectional depiction as sectioned from FIG. 1 to more clearly depict an optional air-through valve.

FIG. 2 is a posterior or rear plan depiction of the air bag simulator device according to the present invention with parts broken away to depict occupied internal volumetric space in a first dimension.

FIG. 3 is a lateral or side view type depiction of a steering wheel with deployed phantom air bag depicting the volumetric space defined by an otherwise deployed air bag in a second dimension.

FIG. 4 is a lateral view depiction of a steering wheel with air bag simulator device according to the present invention exploded therefrom and with parts thereof broken away to depict occupied internal volumetric space in the second dimension.

FIG. 4(a) is a superior or top plan type depiction of a steering wheel (depicted in broken-hidden lines) with an air bag simulator device according to the present invention removably attached thereto and depicting occupied volumetric space in a third dimension.

FIG. 5 is a lateral view depiction of a steering wheel with air bag simulator device according to the present invention removably attached thereto and depicting occupied volumetric space in the second dimension.

FIG. 5(a) is a lateral view depiction of a steering wheel with air bag simulator device according to the present invention removably attached thereto and depicting occupied volumetric space in the second dimension relative to a seated vehicle occupant.

FIG. 6 is prior art schematic diagram of a vehicle occupant restraint system showing a relatively complex arrangement of systems for properly positioning the occupant relative to an air bag deployment zone.

### DETAILED DESCRIPTION OF THE PREFERRED EMBODIMENTS/METHOD

Referring now to the drawings with more specificity, the preferred embodiment of the present invention is believed to essentially embody an air bag simulator device 10 for educating would be drivers and/or vehicle occupants (as at 101) on proper seat-body position relative to a vehicular air bag deployment zone, which zone is generally depicted with broken lining at 11 in FIG. 3. In other words, in the event of an air bag deployment, the broken line boundary or zone 11 depicts that space occupied in a first dimension relative to the steering wheel 12.

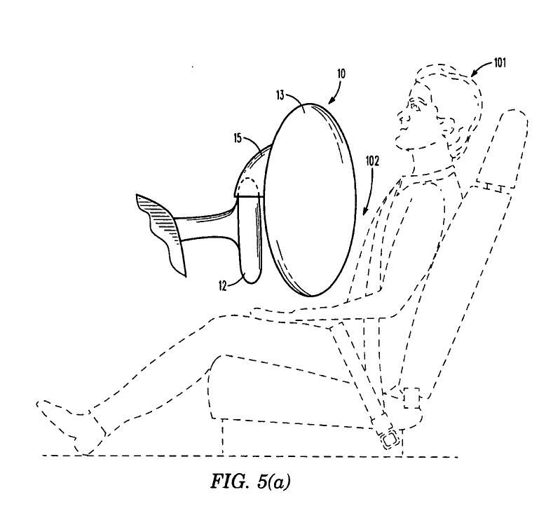

The air bag simulator device 10 according to the present invention mimics that volumetric space 100′ (100 prime) otherwise occupied by a deployed air bag for educating would be drivers and/or vehicle occupants 101 on proper seat-body position relative to a vehicular air bag deployment zone 11 as may be understood from a comparative inspection of FIG. 3 versus FIGS. 5 and 5(a). The air bag simulator device 10 according to the present invention preferably and essentially comprises an air bag-simulating envelope 13.

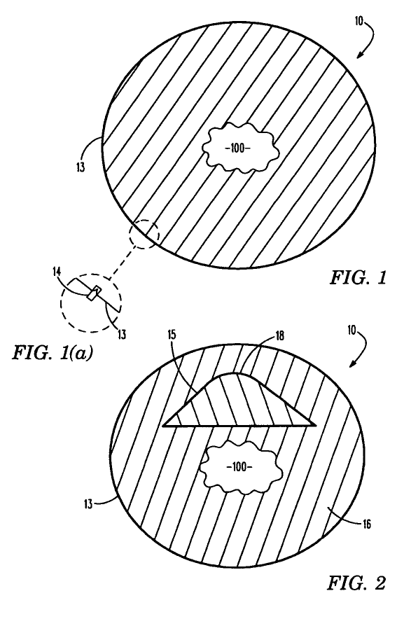

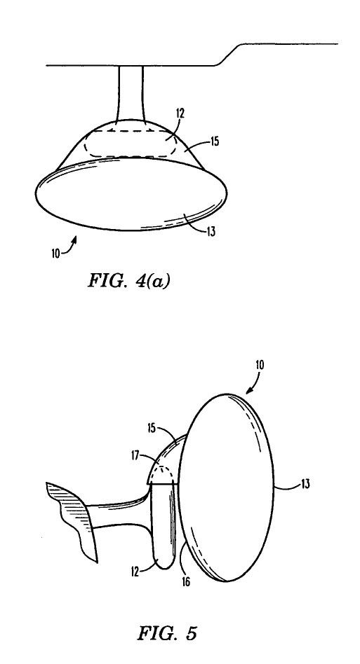

The air bag-simulating envelope 13 is preferably sized and shaped to simulate a deployed driver side, vehicular air bag, and thus the air bag-simulating envelope 13 defines a first volumetric space as at 100 as may be calculated by considering the area generally defined by (1) the circular configuration of the envelope 13 in FIG. 1, (2) the elliptical configuration of the envelope 13 in FIG. 4; and the elliptical configuration of the envelope 13 in FIG. 4(a).

FIG. 1 depicts a frontal or anterior view of the air bag simulator device 10, which, as depicted, is contemplated to be generally circular with a diameter slightly larger than that of a standard steering wheel 12. The air bag simulator device 10 is preferably sized to occupy the same space as a fully deployed vehicle air bag, the diameter of such an air bag being slightly larger than the vehicle steering wheel 12 so that it prevents body parts from coming into contact with the steering wheel 12 during a rapid deceleration as in the event of a front end collision.

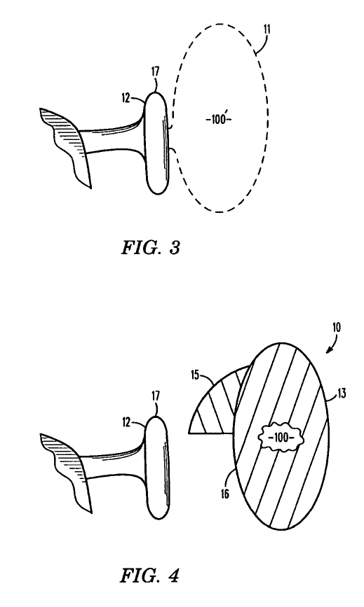

FIG. 2 generally depicts a rear or posterior view of the device 10 with an optional flap or downwardly open pocket 15 attached to the envelope 13. It will be seen from an inspection of FIG. 2 that the upper portion of the pocket 15 comprises a radius of curvature as at 18. The radius of curvature is contemplated to match that of a typical steering wheel such that when the downwardly open pocket 15 receives the upper portion 17 of a steering wheel 12, the air bag simulating device 10 may be removably hung over the vehicle steering wheel 12 so that the device 10 will stay in position during demonstration of air bag deployment.

It is contemplated that the first volumetric space 100 may be filled with various materials or matter all of which is bound by the air bag-simulating envelope 13. In this regard, it is contemplated, for example, that the air bag-simulating envelope 13 may be (1) formed from an air-impermeable, flexible material and filled with air (via a state of the art air-through valve as at 14) or (2) formed in the form of a pillow like construction and filled with pillow-fill type material as exemplified by feathers, down, sponge rubber, or plastic fiber.

In this last regard, it is contemplated that the envelope 13 of the air bag simulator device 10 may preferably be constructed from an air-impermeable, flexible material outfitted with an air-through valve so as to enable a user to direct air into and from the envelope 13 for respectively and selectively inflating and deflating the envelope for use and storage.

When filled with either air or pillow-fill type material or matter, it is contemplated that the envelope 13 essentially functions to provide cushioned support to structures engaging the envelope 13. This simulator can thus be made either of any air tight material so that it may be inflated to simulate a fully deployed vehicle air bag, or deflated for easy storage. Alternatively and optionally, it may be in the form of a stuffed pillow of the size and shape of said fully deployed air bag for easier manufacture and handling.

The envelope 13 is preferably positionable adjacent a vehicular steering wheel 12 for visually demonstrating to a user the first volumetric space 100 otherwise occupied by a deployed driver side vehicular air bag as generally depicted by zone 11 in FIG. 3. In this last regard, it is contemplated that the device 10 further preferably comprises certain wheel-to-device retention means for retaining the air bag-simulating envelope 13 in positioned placement adjacent the vehicular steering wheel 12.

It is contemplated that the wheel-to-device retention means according to the present invention may preferably be exemplified by a downwardly open pocket 15 attached to the rear face or surface 16 of the envelope 13. The downwardly open pocket 15 may thus function to receive the upper portion 17 of the vehicular steering wheel 12 as comparatively depicted in FIGS. 4 and 5. The downwardly open pocket 15 thus permits the envelope 13 to be hung over the vehicular steering wheel 12 for visually demonstrating to the user the first volumetric space 100 otherwise occupied by a deployed, driver side air bag.

In an alternative embodiment, it is contemplated that the envelope 13 of the air bag simulator device 10 may be variously sized and shaped to simulate a deployed vehicular air bag under compressive forces of a vehicle occupant colliding therewith. In this regard, it is noted that air bags deform when colliding with vehicle occupant(s), and thus the size and shape of the envelope 13 may take forms other than those depicted in the various drawings (e.g. generally enlarged). In any event, the air bag-simulating envelope 13 according to device 10 may define a second volumetric space differing from the first volumetric space (e.g. by removing or adding the fill matter within the envelope 13).

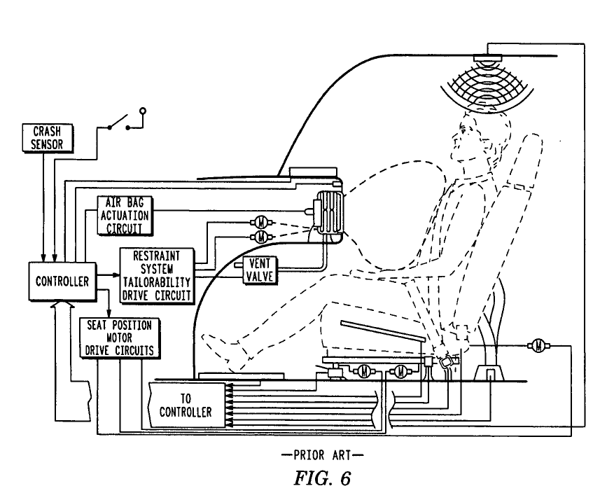

The area defined by the envelope 23 in FIG. 6 and the area defined by the envelope shown in FIG. 7 can be considered to roughly calculate the second volumetric space. It is contemplated that the second volumetric space may also be preferably filled with matter (such as air and/or pillow-fill material) and bound by the air bag-simulating envelope 23, which air bag-simulating envelope 23 is also positionable within a vehicle adjacent vehicular structure such as a vehicular dash board 21 for visually demonstrating to users the second volumetric space otherwise occupied by deployed driver side and passenger side vehicular air bags.

While the foregoing specifications set forth much specificity, the same should not be construed as setting forth limits to the invention but rather as setting forth certain preferred embodiments and features. For example, as prefaced hereinabove, it is contemplated that the present inventive system essentially provides an air bag simulator device for educating would be vehicle occupants on proper body position relative to a vehicular air bag deployment zone.

The air bag simulator device according to the present invention is believed to essentially comprise an air bag-simulating envelope, sized and shaped to simulate a firstly deployed vehicular air bag, and defines a first volumetric space. The first volumetric space is preferably filled with matter bound by the air bag-simulating envelope, which envelope is positionable within a vehicle for visually demonstrating to a user the first volumetric space otherwise occupied by a firstly deployed vehicular air bag.

The device according to the present invention preferably further comprises certain vehicle-to-device retention means for retaining the air bag-simulating envelope in positioned placement within the vehicle. In this regard, the vehicle-to-device retention means may be preferably exemplified by a downwardly open pocket attached to the envelope for receiving the upper portion of vehicular structure such as the steering wheel. The pocket thus permits the envelope to be hung over vehicular structure for visually demonstrating to the user the first volumetric space otherwise occupied by the deployed air bag.

In typical use, a driver or vehicle occupant as at 101 may be instructed to sit in the vehicle in a normal position when about to drive. Then the air bag simulator device 10 may then be placed on the steering wheel 12 so that the driver 101 can see what parts of his or her body come into contact with the air bag simulator device 10, and thus require re-positioning to avoid such contact. The driver 101 may also be told that some additional space (as at 102) is required to allow for body motion at the vehicle speed while a vehicular air bag is deploying.

In addition to the foregoing structural considerations, it is thus contemplated that the same support certain methods for educating vehicle user(s) as to correct body-seat position relative to an air bag deployment zone. The method(s) according to the present invention may be said to comprise the steps of: forming an air bag-simulating envelope; filling the air bag-simulating envelope with matter (the filled air bag-simulating envelope being sized and shaped to simulate at least one deployed vehicular air bag defining a first volumetric space); positioning the filled air bag-simulating envelope within a vehicle; and visually demonstrating to a user the first volumetric space for educating the user as to correct body-seat position relative to an air bag deployment zone.

The filled air bag-simulating envelope may be removably fastened to vehicle structure during the step of positioning the filled air bag-simulating envelope within the vehicle; and certain vehicle structure may be received by vehicle-to-device retention means during the step of removably fastening the air bag-simulating envelope to vehicle structure. The vehicle structure (as exemplified by the steering wheel or portions thereof) is pocket-received by the downwardly open pocket (as at 15) otherwise attached to the air bag-simulating envelope, thereby enabling the user to hang the envelope over the vehicular structure.

It is contemplated that the use of the vehicle air bag simulator device 10 according to the present invention dramatically impresses the driver with the need to sit in the proper position as generally depicted in FIG. 5(a); hold his or her hands in the proper position on the steering wheel 12; and avoid using any device intermediate the driver and the deployment zone 111 where such use would be in the path of an expanding/deploying vehicular air bag.

It is further contemplated that other minor modifications may be required to adapt the device set forth in this disclosure to other vehicles using means well known to those skilled in the art. From the above descriptions it should be readily apparent that the present invention is a simple yet novel device which clearly demonstrates to a driver how he or she has to adjust the vehicle seat and position one's hands to avoid injury during deployment of a vehicle air bag in a crash situation.

Accordingly, although the present invention has been described by reference to certain preferred structural arrangements and certain methodologies, it is not intended that the novel arrangements and methods be limited thereby, but that modifications thereof are intended to be included as falling within the broad scope and spirit of the foregoing disclosures and the appended drawings.

In other words, the foregoing disclosures are offered for public dissemination in return for the grant of a patent. Although the foregoing specifications are detailed to ensure adequacy and aid understanding, this is not intended to prejudice that purpose of a patent which is to cover new inventive concept therein no matter how others may later disguise it by variations in form or additions or further improvements.

I claim:

1. An air bag simulator device, the air bag simulator device for educating drivers on proper seat-body position relative to a vehicular air bag deployment zone, the air bag simulator device comprising:
an air bag-simulating envelope, the air bag-simulating envelope being sized and shaped to simulate a deployed driver side, vehicular air bag, the air bag-simulating envelope thus defining a first volumetric space, the first volumetric space being filled with matter bound by the air bag-simulating envelope, the air bag-simulating envelope being positionable adjacent a vehicular steering wheel for visually demonstrating to a user the first volumetric space otherwise occupied by a deployed driver side vehicular air bag.

2. The air bag simulator device of claim 1 including a wheel-to-device retention means for retaining the air bag-simulating envelope in positioned placement adjacent the vehicular steering wheel.

3. The air bag simulator device of claim 2 where said wheel-to-device retention means comprise a downwardly open pocket attached to the air bag-simulating envelope, the downwardly open pocket for receiving the upper portion of the vehicular steering wheel, the downwardly open pocket thus permitting the air bag-simulating envelope to be hung over the vehicular steering wheel for visually demonstrating to the user the first volumetric space otherwise occupied by the driver side deployed vehicular air bag.

4. The air bag simulator device of claim 1 wherein the air bag-simulating envelope is constructed from an air-impermeable, flexible material, said air bag-simulating envelope being permanently or temporarily inflatable to simulate said deployed vehicular air bag.

5. The air bag simulator device of claim 1 wherein the air bag-simulating envelope is filled with pillow-fill material, the pillow-fill material for providing cushioned support to structures engaging said air bag-simulating envelope.

6. The air bag simulator device of claim 1 wherein the air bag-simulating envelope is re-sizeable and re-shapeable to simulate a dynamic volumetric vehicular air bag, the air bag-simulating envelope thus being re-definable to comprise a second volumetric space different than the first volumetric space, the second volumetric space being filled with matter bound by the air bag-simulating envelope, the air bag-simulating envelope being positionable adjacent a vehicular steering wheel for visually demonstrating to users the second volumetric space otherwise occupied by a deployed vehicular air bag.

7. An air bag simulator device for educating would be vehicle occupants on proper body position relative to a vehicular air bag deployment zone, the air bag simulator device comprising:
an air bag-simulating envelope, the air bag-simulating envelope being sized and shaped to simulate a firstly deployed vehicular air bag, the air bag-simulating envelope thus defining a first volumetric space, the first volumetric space being filled with matter bound by the air bag-simulating envelope, the air bag-simulating envelope being positionable within a vehicle for visually demonstrating to a user the first volumetric space otherwise occupied by a firstly deployed vehicular air bag.

8. The air bag simulator device of claim 7 including a vehicle-to-device retention means for retaining the air bag-simulating envelope in positioned placement within the vehicle.

9. The air bag simulator device of claim 8 where said vehicle-to-device retention means comprise a downwardly open pocket attached to the air bag-simulating envelope, the downwardly open pocket for receiving the upper portion of vehicular structure, the downwardly open pocket thus permitting the air bag-simulating envelope to be hung over vehicular structure for visually demonstrating to the user the first volumetric space otherwise occupied by the deployed air bag.

10. The air bag simulator device of claim 7 wherein the air bag-simulating envelope is constructed from an air-impermeable, flexible material, said air bag-simulating envelope being permanently or temporarily inflatable to simulate said deployed vehicular air bag.

11. The air bag simulator device of claim 7 wherein the air bag-simulating envelope is filled with pillow-fill material, the pillow-fill material for providing cushioned support to structures engaging said air bag-simulating envelope.

12. The air bag simulator device of claim 7 wherein the air bag-simulating envelope is re-sizable and re-shapeable to simulate a dynamic volumetric vehicular air bag, the air bag-simulating envelope thus being re-definable to comprise a second volumetric space, the second volumetric space being filled with matter bound by the air bag-simulating envelope, the air bag-simulating envelope being positionable adjacent vehicular structure for visually demonstrating to users the second volumetric space otherwise occupied by a deployed vehicular air bag.

13. A method for educating vehicle user as to correct body-seat position relative to an air bag deployment zone, the method comprising the steps of:
forming an air bag-simulating envelope;
filling the air bag-simulating envelope with matter, the filled air bag-simulating envelope being sized and shaped to simulate at least one deployed vehicular air bag defining a first volumetric space;
positioning the filled air bag-simulating envelope within a vehicle; and
visually demonstrating to a user the first volumetric space for educating the user as to correct body-seat position relative to an air bag deployment zone.

14. The method of claim 13 wherein the filled air bag-simulating envelope is removably fastened to vehicle structure during the step of positioning the filled air bag-simulating envelope within the vehicle.

15. The method of claim 14 wherein vehicle structure is received by vehicle-to-device retention means during the step of removably fastening the air bag-simulating envelope to vehicle structure.

16. The method of claim 15 wherein vehicles structure is pocket-received by a downwardly open pocket attached to the air bag-simulating envelope, the air bag-simulating envelope thereby being hung over vehicular structure.

17. The method of claim 13 wherein the air bag-simulating envelope is constructed from an air-impermeable, flexible material, and comprises an air-through valve, the method comprising the step of directing air through the air-through valve during the step of filling the air bag-simulating envelope with matter.

18. The method of claim 13 wherein the air bag-simulating envelope is filled with pillow-fill material during the step of filling the air bag-simulating envelope with matter.

19. The method of claim 13 wherein the firstly deployed air bag is re-sized and/or re-shaped to simulate a dynamic volumetric vehicular air bag, the air bag-simulating envelope thus being re-defined to comprise a second volumetric space, the second volumetric space being filled with matter bound by the air bag-simulating envelope.

20. The method of claim 13 wherein the method comprises the step of emptying the air bag-simulating envelope of matter after the step of visually demonstrating to the user the first volumetric space.
